(19) United States
(12) Patent Application Publication
(10) Pub. No.: US 2008/0133284 A1
(43) Pub. Date: Jun. 5, 2008

(54) TRAVEL FORECASTING AND ALLOCATING SYSTEM AND METHOD

(76) Inventors: GRANT DAVON BIRCH, BRIDPORT (AU); SHAWN IVOR SCHUBOTZ, GERMISTON (ZA)

Correspondence Address: G. Birch, 75 WESTWOOD STREET, BRIDPORT, 7262, omitted

(21) Appl. No.: 11/949,062

(22) Filed: Dec. 3, 2007

(30) Foreign Application Priority Data
Dec. 5, 2006 (AU) 2006906767

(51) Int. Cl. G06Q 10/00

(52) U.S. Cl. 705/5

(57) ABSTRACT

A travel forecast and allocation computing system and method for prospective and other travel purchasers to access for requesting, receiving, and re-allocating rights to travel on passenger transportation vehicles, whereby a travel purchaser may have an opportunity of re-allocating its purchased right to travel to one or another of travel purchasers by trading it, and whereby a travel provider may have an opportunity of efficiently allocating transport to service binding travel requests and have further opportunity of relief from providing changes to reservations. The present invention makes possible economic incentive for travellers to forecast their own travel behaviour, and enable economic incentive for travellers to commit far into the future to specific travel so that airlines need not rely on their own forecasting of demand to plan their operations.

### CROSS REFERENCE TO RELATED APPLICATIONS

This specification is related to a priority provisional patent application 2006906767 titled ‘Travel forecasting and allocation system and method’ filed in the Commonwealth of Australia on 5 Dec. 2006 by G. D. Birch.

### FEDERALLY SPONSORED RESEARCH

Not applicable

### SOFTWARE PROGRAM

Not applicable

### BACKGROUND OF THE INVENTION

1. Field of Invention

This invention generally relates to a business method of using a network of computers to create and allocate or otherwise dispose of travel forecasts, travel requests, and travel inventory, particularly by using the internet for passenger airline travel.

2. Prior Art

Scheduled airlines need to forecast travel demand in the future to plan their operations. Scheduled airlines firstly forecast travel demand, secondly allocate resources in the form of scheduled flights to supply the forecasted demand, and thirdly sell reservations on the flights. By forecasting in this manner, the scheduled airlines attempt to match supply and demand.

Air travel especially is not a primary service since it is generally not purchased for the experience itself, but so that the traveller may do something at or near the destination. So travel demand is based on other primary traveller needs such as holidays, visits, business, or other events. To make good forecasts an airline needs to study historical travel patterns, traveller needs, and to track its ticket sales.

There is much chance of forecast error. Faulty forecasting can mean loss of profit opportunities. Yet forecasting of passenger travel demand is currently and historically so critical for the planning of scheduled airline operations.

It happens often that a flight is never fully booked; in which case a mismatch of the numbers of passengers and the numbers of seats supplied, based on forecasting, is ongoing until the flight takes place. Often a flight is only fully booked very close to the time it takes place, or even when fully or partially booked its seat reservations are changed by travellers as their travel plans change.

When airlines have allowed travellers to change their travel reservations, the airlines are not precisely sure of the numbers of passengers. When airlines have sold ‘use or lose’ tickets to travellers, preventing changes to reservations, most travellers have waited until the last few days before a flight to commit to purchasing a place on the flight. In both such cases an airline is still unsure of passenger numbers until very close to flight time.

In the scheduled airlines' business method a proposed flight journey awaits demand to fill it, yet at a certain point in time it cannot wait any longer for more passengers as there is a fixed departure time. So there is a likelihood of a mismatch of the number of physical seats supplied and the number of passengers.

Mismatched number of passengers and the supply of seats represent wasted resources or opportunities. Empty passenger seats represent wasted resources even when a flight is profitable. Perhaps an airline lost income from empty seats, or perhaps passengers paid more than necessary, because of the empty seats.

The result of competition using the scheduled airline's business model has been characterised by overcapacity. The wasted resource of overcapacity must be funded by airlines, travellers, unpaid creditors, or taxpayers.

Charter airlines do not have the same problem as scheduled airlines, and are able to supply a flight to already committed travel demand, rather than to forecasted demand. Yet the charter airline business model is limited in that it does not reach out to the general travellers' market. The charter airlines are generally limited to selling their services to entities such as tour operators who themselves cover the wholesale costs of the travel services.

So the entities that charter flights wholesale are limited in turn, to their ability to collect together sufficient individual passengers in advance to make up a flight. Charter airlines do not reach all types of travellers.

3. Discussion of Basic Theory of Prior Art

The following theory discussion is provided by one of the inventors so as to give his viewpoint of the allocation of passenger travel. Since it is only a simplified viewpoint for the purpose of highlighting features of the prior art the inventors do not want to be bound to the theory in any way.

There are two main ways, or in other words methods, to allocate travellers to journeys. The first main method is when transport waits for passengers to fill it up. The second main method is when travellers wait for transport to arrive.

The first main method includes at least two secondary ways or in other words business models here called model 1 and model 2.

Model 1 is when transport waits for sufficient passengers before making its journey. Model 1 can efficiently match physical supply and demand, yet the disadvantages are that both the transport and travellers must wait for more travellers and are not sure when the journey will take place.

In model 2 transport waits for passengers to fill up but it has a fixed departure time and so at a certain point in time it cannot wait any longer for more passengers. Model 2 is effective for both the transport and passengers in that they are certain of the journey time, yet it can be an inefficient way of matching physical supply and demand. Scheduled airlines follow this model 2 but neither the transport nor the passengers need to be physically present as the airlines use a computerised reservation system which provide a conceptual scheduled flight corresponding to a flight planned in the future, and a conceptual list of names of real travellers who have committed to the flight.

The second main method includes at least two secondary business models henceforth called model 3 and model 4.

Model 3 is when travellers wait for transport while sufficient travellers form up in a queue. If the queue is larger than the transport, then it is an efficient and fair way of matching physical supply and demand, but the disadvantages are that travellers need to wait for transport and possibly also wait for other travellers.

Model 4 is when travellers wait for transport that they have already ordered. Ad hoc charter of flights or ordering a personal taxi follow this way and are generally a more expensive means of transport, since transport must cover a cost of slackness and uncertainty of demand.

Model 1 and model 3 allow for complete matching of physical travel supply and demand. Yet the airline industry relies on a conceptual method of model 2 for scheduled flights or a conceptual method of model 4 for charter flights.

The airline industry values some travellers on a journey over others on the same journey. The industry relies on yield or revenue management to charge different fares to different travellers on a flight according to each traveller's utility demand. This industry reliance on revenue management complicates the industry's thinking so that it does not think in the above simple ways of matching physical supply and demand.

The airline industry has relied on booking lists and especially computerised reservation lists. The computerised reservation system represents a conceptual aircraft waiting for conceptualised passengers to fill it before a predetermined flight. This corresponds to a conceptual model of model 2 allocations. The booking-lists method means that a traveller is either placed on a flight or not, rather than queued.

This reliance on conceptual flights and corresponding bookings has meant that the industry creates travel inventory before travellers request it. An airline in effect foresees an imaginary crowd of travellers, and then it creates the corresponding travel inventory for the imaginary crowd.

It is here emphasised that an airline foresees an imaginary crowd and not a conceptualised queue of real travellers. This is the source of prior art travel demand forecasting. Since reality cannot always correspond to the imagined crowd the airline is then likely not to sell the entire travel inventory created.

Scheduled airline reliance on forecasting is based on airline conceptual use of model 2 allocation. All prior improvements to airline travel allocation are based on thinking ‘inside the box’ of model 2.

Within the thinking of the model 2, the value of traveller self-forecasting is unrecognised.

Within thinking of model 2 allocations, trading and transferability of tickets is seen as a corruption of yield management and its value is unrecognised by airlines. Accordingly non-transferable tickets, non-assignable tickets are the norm.

Within the thinking of yield management, i.e. within conceptual model 2 allocations, a late booking traveller is more valuable and is charged more, while early bookers have limited value, as an airline relies on realising its forecasted demand. This thinking teaches against the value of creating long term committed demand.

A bus that continuously shuttles back and forth would be an example of travellers' queuing for a bus service that does not have a definite time schedule. This is a form of traveller self-imposed travel forecasting. This is so because the bus has as yet, not accepted a queued traveller. It cannot be said that a queued traveller is booked on the bus since it may prove that there is no space on the bus. Yet a queued traveller represents an unplaced commitment to travel on a bus. And as such a queue represents a traveller demand forecast. The continuance of a queue represents forecasted demand that is visible to the bus driver, so that more buses may be allocated to supply this demand.

Queuing is frustrating for travellers as they are bound in time and space and are not free for many other activities while so occupied.

Airline travel has used a conceptual queue in the case of a wait-list booking. This is a queue of names of travellers wanting to get a booking on a flight already fully booked. A traveller on a wait-list may be lucky to get a booking if an already booked passenger decides to cancel his/her booking.

The wait-list booking is used in the prior art for a model 2 allocation. The wait-list is not used for unfilled flights (outside model 2). In fact the conceptual queue of traveller names is not used for unfilled flights or other journeys. More especially the conceptual queue is not used for unfilled mooted journeys.

Various economic incentives have been made or proposed for travellers in the prior art. Examples include loyalty programmes such as Frequent Flyer points, choices of naming your own price for fares, cheaper options on flexibility in transport, or even transferable tickets. Yet to the present inventors knowledge all such economic incentives have been offered to sell or utilise existing inventory (i.e. transport already committed to be provided). To our knowledge economic incentives have not been applied to first create a pool of demand that may then be satisfied by transport providers.

### OBJECTS AND ADVANTAGES OF THE PRESENT INVENTION

An object of the present invention is to provide a device and method that creates sufficient committed traveller demand far enough into the future to allow an airline to plan its operations to meet the demand; rather than the airline selling journey places on already scheduled travel supply which was based on forecasting.

Achieving this object removes the previously critical need for the airline to forecast that traveller demand. It is a considerable advantage of the present invention to the airline industry that the risk of losses to an airline caused by incorrect forecasting is then dissipated or lowered.

Furthermore it is an advantage in certain embodiments of the present invention to travellers that they may be able to harness and employ traveller rights whilst using the invention. Indeed the advantage to a traveller is that the present invention facilitates the possibility of transferring a right to travel on a journey (or in other words effectively a ticket) to another traveller by assignment.

Furthermore the present invention facilitates, besides the transferring, also the trading of a right to travel on a journey, commonly thought of as a ticket, with other travellers.

The trading suggests the advantage of efficient allocation of traveller demand.

Economic incentives may be gained from traveller exploitation of traveller rights employed on the invention. These economic incentives may include travellers profiting from a travel purchase, or minimising the risk of not using travel that has already been purchased.

Another advantage to travellers is that they may be provided an opportunity to gain other economic incentives in return for forecasting and committing their own travel demand.

These other economic incentives may include paying a price of choice, being placed on the seat of lowest possible price, being able to pay a period after committing to a journey, or being able to pay for a journey in installments.

Airline operations are characterised by high costs, perishable services, and supply units (i.e. aircraft flights) composed of many consumer units (i.e. aircraft seats). These characteristics require a high level of planning to consistently and sustainably provide profitable services. So the present invention will be economically useful both to airlines and travellers because of the following reasons.
If airlines were able to plan to committed specific travel demand far into the future, rather than to their own forecasts, they would be more able to consistently and reliably plan their operations economically.
Another advantage of the present invention is to put travellers in a powerful position to themselves join their travel forecast demand with other travellers to create purchasing leverage.

This suggests the advantage of a win—win model for both travellers and travel suppliers based on efficient utilisation of resources.

### SUMMARY OF THE INVENTION

The present invention facilitates economic incentive for travellers to commit far into the future to specific travel—to induce travellers to effectively forecast their own travel behaviour; so that airlines may rely on such committed traveller forecasts which are binding, and need not rely on their own uncertain forecasting of demand to plan their operations by.

Travellers themselves are in the best position to judge and forecast their own travel, as they know best the factors affecting their travel decisions. If many travellers make requests for travel, the requests can be combined to effectively create a forecast of traveller demand.

Since traveller requests are binding offers, an ensuing forecast is binding too, unlike firstly, an uncertain forecast of the prior art.

Furthermore, all, or the best parts of a forecast may or may not be converted as and when suitable, into a group of binding contracts of carriage for predetermined and fixed travel criteria; unlike the prior art which still has a second uncertainty of ticket sales after making a forecast.

Still further, travellers may trade their accepted requests, or in other words contracts of carriage, with other travellers to efficiently allocate changes to travel plans, while preserving the accepting travel provider's sales; unlike the prior art when it allows a third uncertainty of sales allocation to predetermined journeys with mobility of reservations.

In the present invention tickets are fixed to a predetermined journey, but travellers themselves are free to re-allocate their tickets, if possible, between themselves; while in the prior art travellers bound to their tickets move between predetermined journeys, if possible, when changes to reservations are made.

The present invention therefore removes at least the above mentioned three uncertainties of travel demand found in the prior art.

### Broad Statement of Invention

According to a first aspect of the present invention, a travel forecast and allocation computing system for prospective and other travel purchasers to access for requesting, receiving, and re-allocating rights to travel on passenger transportation vehicles, comprises:
(a) forecasting means for multiple travel purchasers each to register requests in the computing system; wherein a first request, of said requests, records a binding offer to purchase travel on a mooted first journey having criteria chosen by a first travel purchaser at a fare price predetermined by said first travel purchaser, and wherein said first request provides that it may or may not be accepted, and if accepted shall be converted to a respective first right to travel, whereby if accepted, said first request shall be serviced by said first right to travel on said first journey, and
(b) trading means for a second travel purchaser to facilitate selling of a second right of travel to a third travel purchaser, who in turn may sell said second right to travel to a fourth travel purchaser, wherein said second right to travel was supplied as acceptance of a second request, by a travel provider, for travel on a second journey, whereby a travel purchaser may have an opportunity of re-allocating its purchased right to travel to one or another of travel purchasers by trading it, and whereby a travel provider may have an opportunity of efficiently allocating transport to service binding travel requests and have further opportunity of relief from providing changes to reservations.

In accordance with a second aspect of the present invention a method of forecasting, allocating, and re-allocating traveller demand for travel services comprises:
(c) providing a computing system, that is accessible to prospective and other travel purchasers by remote end user terminals in a distributed network, and
(d) providing forecasting means for multiple travel purchasers each to register requests in said computing system; wherein a first request, of said requests, records a binding offer to purchase travel on a first journey having criteria chosen by a first travel purchaser at a fare price predetermined by said first travel purchaser, and wherein said first request provides that it may or may not be accepted by a first travel provider supplying a first right to travel on said first journey, and
(e) providing said first right to travel as acceptance of one of said requests, wherein said first right to travel is an assignable record of a right, registered in said computing system, provided by said first travel provider to said first travel purchaser for passenger travel on said journey of predetermined criteria, and
(f) providing trading means for said first travel purchaser to facilitate trading of said first right of travel on said computing system, to a second travel purchaser,
   whereby a travel purchaser may have an opportunity of re-allocating its purchased right to travel to one or another of travel purchasers by trading it and whereby a travel provider may have an opportunity of efficiently allocating transport to service binding travel requests and have further opportunity of relief from providing changes to reservations.

According to a third aspect of the invention a method of forecasting and allocating traveller demand for travel services comprises:
(g) providing a computing system, that is accessible to prospective and other travel purchasers by remote end user terminals in a distributed network, and
(h) providing forecasting means for multiple travel purchasers each to register requests, wherein a first request, of said requests, records a binding offer to purchase travel on a mooted first journey having criteria chosen by said first travel purchaser at a fare price predetermined by said first travel purchaser, and where said first request provides that a travel provider, of a number of providers, may choose whether or not to put a mooted journey into service, for the request, and
(i) providing a decision means for selecting some of said requests into a grouping of requests which form an economically viable scenario of travellers that may be serviced if a number of transport journeys are put into service, and
(j) accepting said grouping of requests conforming to said economically viable scenario, and
(k) providing a group of rights to travel as respective acceptance of said grouping of requests, wherein each right to travel of the group, is an assignable record provided by a travel provider to a travel purchaser for a passenger right to travel on a journey of predetermined criteria,
   whereby a travel provider may have an opportunity of efficiently allocating transport to service binding travel requests.

According to any aspect or embodiment, the present invention may further comprise a number of optional elements selected from the group of following preferred elements:

### Preferred Elements Relating to Access

a preferred website means for making the invention accessible on a website to many travellers,
a preferred first identification means to register personal details of travellers,
a preferred second identification means to register a traveller as a sole group of a number of indicia,
a preferred third identification means to provide a traveller with knowledge of the indicia which register its traveller-identity,
a preferred first exclusive means for a traveller to have exclusive use, operation, or adaptation, or exclusive confirmation of use, operation, or adaptation of a communication feature,
a preferred fourth identification means for a traveller to access the first exclusive means by providing the indicia which register its traveller-identity in the second identification means,

### Preferred Elements Relating to Travel Requests

a preferred first forecasting means for a travel purchaser to make a number of travel requests, and where the travel request provides that a travel provider has a right to choose whether or not to make one or more future journeys on a transportation means available to the purchaser and if it makes a journey available, the travel purchaser has an obligation to pay for the last-mentioned journey and thus receives a right to travel, and
a preferred second forecasting means for a travel purchaser to make a series of a number of automatic requests for travel at predetermined intervals,
a preferred first communication means for a travel purchaser to send information of the number of travel requests,
a preferred first register means to register the travel requests,
a queuing means for multiple travel requests to form up into various conceptualised queues for mooted journeys that match the requests,
a preferred broadcasting means for some travel purchasers to inform each other of their registered requests; this feature helps travellers determine their chances of being selected as part of a bundle of requests, so that each traveller may adjust its offered fare price to maximise the chances of placement according to what other offers other travellers have made,
a preferred first search means for a traveller to search travel requests made by various travel purchasers,

### Preferred Elements Relating to Decision Process

a preferred first decision means to process travel requests into economically viable scenarios that may or may not be serviced; so that a travel provider may decide to service the requests that comprise an economically viable scenario, wherein said viable scenario is selected from a group consisting of an aircraft journey, round trip, route, and routes; so the first decision feature collects a request together with a number of similar requests to form a bundle of requests,
a preferred second decision means which decides which is an optimum viable scenario out of a group of various economically viable scenarios,
a preferred third decision means which decides on an optimum point in time for the travel provider to accept a bundle of requests composing the optimum viable scenario,
a preferred second communication means whereby a bundle of requests composing an optimum scenario is offered to a travel provider to agree to service; which bundle of requests the travel provider may accept or not,
a preferred fourth decision means for a travel provider to make a final decision of accepting a number of requests; wherein computing means operate to fourth decision algorithms having parameters predetermined by a travel provider.

### Preferred Elements Relating to Request-Acceptance

a preferred acceptance means for a travel provider to commit to providing a number of rights to travel by acceptance of the number of respective travel requests.
providing rights to travel that match the journey criteria of at least some of said requests, wherein each right to travel is a right provided by a travel provider to a travel purchaser for passenger travel on a journey of predetermined criteria,
a preferred second registering means that issues and registers a right to travel to those travel purchasers whose requests have been chosen to be serviced; wherein, when a travel provider accepts an request, the travel purchaser has an obligation to pay for a corresponding journey and thus receives a right to travel on the journey; in other words, an accepted travel request confers a right to travel on a specified journey to a title holder; there is and can only be one title holder to each right to travel at any point in time; a right to travel is for specified, or in other words predetermined, travel criteria relating to a passenger place on a specific journey; a right to travel may be an assignable right provided by a travel provider to a travel purchaser for passenger travel on a journey of predetermined criteria,

### Preferred Elements Relating to Payments

a preferred payment means to facilitate payments by, to or between travellers, travel purchasers, travel providers, banks, travel agents, travel merchants, or other users, for the purposes of offers, offer deposits, rights to travel, tickets, taxes, commissions, fares, or other fees resulting from using the invention,

### Preferred Elements Relating to Trading

a preferred first trading means that facilitates a trading process of a first travel purchaser selling an owned and registered right to travel to a second purchaser; which gives the first travel purchaser a method and device for finding and replacing itself, on a journey, with another willing traveller,
a preferred second search means for a traveller to search rights to travel that have been offered up for sale by the owning travel purchasers,
a preferred first window period means for inhibiting trading of a right to travel within a predetermined period of time before its journey,

### Preferred Elements Relating to Options

a preferred options means for a travel purchaser to make a put or call contract option on a right to travel with another traveller,
a preferred exercise means for a travel purchaser who holds an option on a right to travel to exercise the option and only within the option's exercise period,
a preferred third window period means for inhibiting the exercise of an option a predetermined period before a journey,
a preferred third search means for a traveller to search options on rights to travel that have been offered up for sale by the owning travel purchasers,
a preferred second trading means for travel purchasers to trade the options on rights to travel,
a preferred second window period means for inhibiting trading of an option on a right to travel a predetermined period of time before its journey,

### Preferred Elements Relating to Notification

a preferred third communication means to notify a title holder of any change of status of any held travel request, right to travel, option contract, or account,
a preferred nomination means for a travel purchaser owning a right to travel to exclusively nominate (and change nomination of) a passenger for the right to travel,
a preferred counter-offer feature for a travel provider to suggest a counter offer to an offer made in a travel request,

### Preferred Elements Relating to Match-Making

a preferred match-making feature for automatic acceptance of a travel request by an offer to sell a matching right to travel,

### BRIEF DESCRIPTION OF DRAWINGS

FIG. 1 shows hardware in a computerised network for operation of the invention.

FIG. 2 shows basic flowchart of invention use, illustrating operator processes in bold boxes and computer means in normal boxes.

### DETAILED DESCRIPTION OF USE OF THE PRESENT INVENTION

### A first example of the present invention and method of use is now described in the following detailed description.

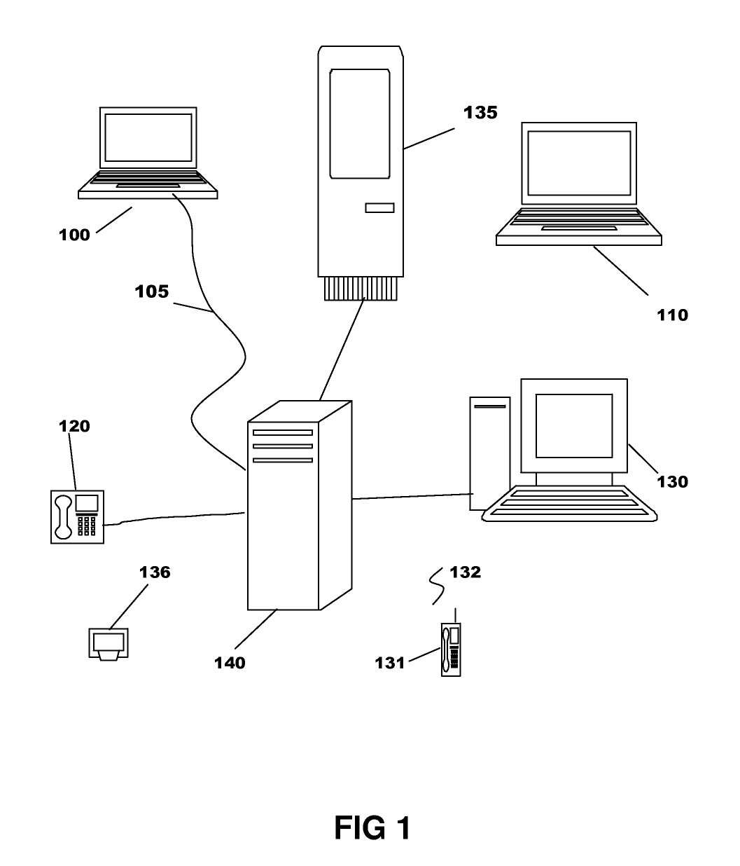

Refer now to FIG. 1 which illustrates an example of the hardware of the invention, wherein many computers of different variety are shown. Each type of computer or computer terminal may be used in this example.

FIG. 1 illustrates types of computers and computer terminals, including computing devices such as a wired laptop computer 100, a wireless laptop computer 110, a landline telephone 120, a desktop personal computer 130, a computing mobile cell phone 131, a palm top computer 136, and a computing kiosk 135 (similar to that of an automatic teller machine but which is accessible to travellers), which are connected to each other via interconnected web servers by an internet or intranet, one of which is shown as a master server 140 which hosts software, including a database management system and a website, for the invention.

These computers are characterised in that they:
(a) use software,
(b) have a display and/or a speaker for transmitting information to a traveller,
(c) have a keypad and/or a microphone for a traveller to enter information into or otherwise adapt or operate,
(d) provides travellers with access to a website (or similar equivalent) of the invention,
(e) may be operated by travellers for a variety of actions relating to ordering, buying and selling travel,
(f) may receive and dispense a variety of information, from one or more master servers, to travellers, and
(g) may send remote information from travellers operating them, to at least one master server that hosts database and other software which gets adapted by the information.

Similar computers are also connected by the internet that:
(h) may optionally provide travel providers with access to a database of the invention,
(i) and may optionally provide software hosts with access to a database of the invention.

An internet service provider hosts a travel forecasting and allocating system website, which is accessible to multiple travellers and travel providers, for a travel club.

Travellers are here generally meant to be people and other entities contemplating, or executing the purchase of, or using of, passenger travel on transport vehicles. Travel purchasers are here generally meant to be a sub-set of travellers that have committed or may commit to purchase passenger travel. So a person or entity may be both a traveller and a travel purchaser.

Travel providers are here meant as entities that commit to supplying travel services. So travel providers may be for example airlines, or travel merchants who have engaged a service of an airline. But travel providers may also purchase travel, and so take the role of traveller or travel purchaser.

Passengers are here meant to be a sub-set of travellers that are natural persons who actually travel on a vehicle.

### Home Page

The website has a home page for first access by travellers.

The homepage has an access link to a registration webpage for new users to register with the travel club.

The homepage has a link for each registered user or traveller, to log-in to its own exclusive registered traveller webpage.

The homepage has a link to search means for searching other webpages of the website.

### Search Means

A first search means is a software database search engine for a traveller to search travel requests made by various travel purchasers.

A second search means is a software database search engine for a traveller to search rights to travel that have been registered as up for sale by the owning travel purchasers.

A third search means is a software database search engine for a traveller to search options on rights to travel that have been registered as up for sale by the owning travel purchasers.

### Registration Page

The registration webpage is a secure web page which has entry places for a traveller to enter its personal details. The entries are for traveller:

(a) acceptance of website rules and travel use rules,
(b) personal identification details,
(c) personal contact and addresses, and
(d) personal banking information.

### Registered Traveller Database

A registered traveller database has a first identification means, which registers personal information entered in the registration page.

Included in each registered traveller's register is a second identification means of secret code data, or biometric data exclusive to each traveller which may be matched by a remote entry to confirm identity of the traveller.

The registered traveller database as a whole is not accessible by travellers or travel providers, but only by the travel club, unless the travel club is perhaps also the travel provider.

### Log-In Means

A registered traveller needs to be informed, or otherwise provided with indicia or data, by a third identification means, of the indicia registered in the registered traveller database as his identity. This may be biometric reading of the person, providing part or parts of a secret code upon personal identification, or other state of the art identification methods.

A fourth identification means in the master server matches respective data in the traveller database, with secret data or biodata entered by a traveller, to confirm identity and provide exclusive access before exclusive use, or to provide a signature to confirm exclusive use after access and operation of its own registered traveller webpage.

### Registered Traveller Webpage

A unique registered traveller webpage is available for each registered member of the travel club to view and operate exclusively. A registered traveller website may only be accessed by its respective traveller, using the fourth identification means, when the traveller logs-in using secret numbers, codes, provides biometric data, or other secure means.

Each registered traveller webpage has two main sections, a registered traveller information webpage for viewing personal information and a registered traveller operations webpage for a traveller to dispense information.

### Registered Traveller Info Section Webpage

The registered traveller webpage shows information garnered from a respective database:

(a) the registered traveller details registered in the database software,
(b) lists any current travel requests that the respective registered traveller may have registered,
(c) any rights to travel that the registered traveller currently holds,
(d) any options on rights to travel that the registered traveller currently holds,
(e) and a statement of account of the registered traveller's internal money account.

### Registered Traveller Operations Section Webpage

Each registered traveller webpage has a first exclusive means for each respective registered traveller to adapt and then send information to a master server:
(a) to make a travel request,
(b) to cancel a travel request,
(c) to offer up for sale, an owned right to travel,
(d) to cancel an offer for sale,
(e) to buy another offered right to travel from another travel purchaser,
(f) to write or offer an option on a right to travel,
(g) to cancel an option offer,
(h) to buy an option offered by another traveller,
(i) to exercise an option on a right to travel,
(j) to nominate a passenger for an owned right to travel,
(k) to change a passenger nomination,
(l) to pay money into the registered traveller's own internal account,
(m) to pay money out of the registered traveller's own internal account,
(n) to change personal details.

### Travel Request Webpage

A travel request webpage is a first forecasting means for a registered traveller to take the role of a travel purchaser in making at least one travel request in the form of an offer to purchase travel on a journey of criteria predetermined by the travel purchaser.

The travel request webpage must be accessed, or its entries confirmed, by the registered traveller from its secure personal exclusive registered traveller webpage. In another embodiment it may be accessed or confirmed directly by the fourth identification means.

A travel purchaser responsible for a travel request must choose journey travel criteria on this webpage, choose an offer fare price, make sufficient funds for the fare available, may choose to link the request with a number of other requests, and may choose the request's offer time period.

At any point in time the travel purchaser of a travel request may by the same means remove its request—provided it has not yet been accepted.

A registered traveller may on the same webpage choose to make one, or a series of requests, automatically in the future by a second forecasting means.

A confirm button on the travel request webpage activates a first communication means for sending a travel request to the master server.

### Travel Request Register

Each current travel request is registered in a travel request database in a memory of the master server.

Each travel request has an exclusive identifying code. The register records the criteria of the travel request including its offer price and its travel purchaser creator.

The register as a whole can be viewed only by the travel club.

### Flight Queue List Webpage

There is a flight queue list webpage for each mooted flight journey accessible to general public users.

A queuing means lists in a flight queue list database, from highest to lowest, respective offers of travel requests made by travellers having matching travel criteria. The queuing means reads the travel request register and posts a copy to each flight queue list of matching travel criteria. The fare offer price with its identifying code is sent to each corresponding flight queue list.

If a travel request gets accepted by a travel provider or is otherwise removed, the respective posted request or requests is also removed from the respective flight queue list or lists.

Each flight queue list webpage displays each respective flight queue list read in the flight list database, and therefore serves as a broadcasting means.

A travel request identifying number with its respective offered fare price is shown without the identity of its travel purchaser. A traveller may view all the requests made for a specific flight journey, in the form of a list which is effectively a queue for the journey. A traveller may find its request number in the queue and view its position to judge its chances of acceptance. A registered traveller may remove its travel request or may change a request's offer price.

So each traveller's utility demand will determine its offer price in relation to other traveller's utility demand, and a request's respective position in a journey queue.

### Decision Process

A first, second, and third decision means is a computer which may be the master server or another computer which may use data provided by the master server; which is programmed by software which makes logical decisions based on algorithms. The algorithms create virtual reality scenarios of various routes of journeys holding some of the current travel requests. A number of possible scenarios may be entered into the first decision means by a potential travel provider; the decision means reads the travel request register to test each travel request for entry into each scenario.

The decision means continuously provides, or in other words offers, suitable scenarios, if any, to a travel provider by a second communication means, for acceptance. The second communication means may be an exclusive scenario webpage for the travel provider, email, or telephone. When a scenario is accepted, it is accepted in the form of a bundle of requests.

### Request Acceptance

A travel provider may accept a number of single travel requests. But this invention teaches the advantages of a travel provider accepting a bundle of requests which comprise a suitably economic scenario of journeys. Even when a bundle of requests is accepted, the effect to an individual traveller is the same as for a single request acceptance.

Whether or not a request is accepted as part of a bundle, the request is converted to a right to travel, and is thus confirmed, when a travel provider operates an acceptance means.

The acceptance means may be operable by the travel club acting on instructions from an accepting travel provider, by a travel provider manually accessing a scenario webpage and accepting a scenario therein, or by a travel provider's computerised fourth decision means accessing and operating the scenario webpage or a scenario database or equivalent.

The respective request is removed from the travel request register, and a corresponding right to travel created in a right to travel register by a second registering means.

A respective request's fare price that was predetermined by an offering registered traveller is billed to the traveller's account by a payment means which is initiated by the second registering means.

### Scenario Webpage

The scenario webpage has its access limited to travel providers and the travel club.

### Right to Travel Register

A right to travel register, second registering means, is a database stored in memory of information on each current right to travel. The register holds information on:

distinct identifying number/code,
each travel criteria relating to the predetermined respective journey,
the one and only current registered traveller title holder,
the one and only currently nominated passenger.

Once a journey takes place the respective right to travel ceases.

### Payment Means

Payment means include computing database accounting means for recording transactions and the state of internal and external money accounts.

Internal accounts are accounts held within the travel club which include deposit accounts, funds awaiting clearance account, and a cash account.

External accounts such as bank or other money accounts held outside the travel club may be linked to the payment means so that the payment means may directly pay funds or receive funds from or to such accounts. External accounts may be used for direct payments of travel services, or to pay into a travel club account. Web pages requiring payments are the access to, and include the payment means.

### Trading Means

A first trading means includes all devices and processes for:

offering up a right to travel for sale,
for accessing and accepting the offer,
for registering change of ownership in the right to travel register.

A registered traveller, who has purchased a right to travel and is the current registered owner of the right to travel, may offer it up for sale from its own registered traveller webpage. This offer is posted to a ticket-sell-offers list in a respective database. Another traveller may search the ticket-sell-offers list and then if also a registered traveller, holding sufficient funds may purchase the right to travel by importing the offer into its own registered traveller webpage, and by paying for the offer with the payment means.

### Match-Making

The match making means is a database software program that will automatically find an offer to sell that matches an offer to buy and then automatically enable the sale transaction, including the necessary payment and change of ownership registration.

### DESCRIPTION OF DRAWINGS

One traveller E of many travellers contemplating using air travel in the future decides to log onto the internet travel club website, a website means. Referring now to FIG. 1 which illustrates the hardware of the invention, the traveller E uses computer laptop 100 to access the website. The website is hosted in server 140 and all website information is transmitted via telephone line 105.

The website prompts the traveller E to register and receive a registered traveller identification code. The traveller E registers her personal details and her credit card number on a secure registration webpage, a first identification means, of the website. The first identification means is a component of a software database stored in computer memory of server 140. The traveller E also types in her acceptance of website and travel club standing rules. The traveller E also types in a chosen personal identification number, which gets registered in a second identification means of the software database. Then subsequent to the travel club entity accepting the traveller E as a registered traveller, the traveller E is exclusively forwarded, by a third identification means, an email in this example, of an exclusive registered traveller identification code, a third identification means.

By a fourth identification means, from the website, the traveller E uses the personal identification number and the registered traveller identification code, to access a secure travel requests webpage of the website. The travel requests webpage, a first forecasting means, prompts the traveller E to open an internal money account, which is part of a payment means, of the travel club, if the traveller E wants to make any travel requests. By following prompts and help advice posted on the webpage the traveller E gives authority (by a first exclusive means) to transfer money (by payments means) from her credit card account to a travel club internal money account controlled by her alone.

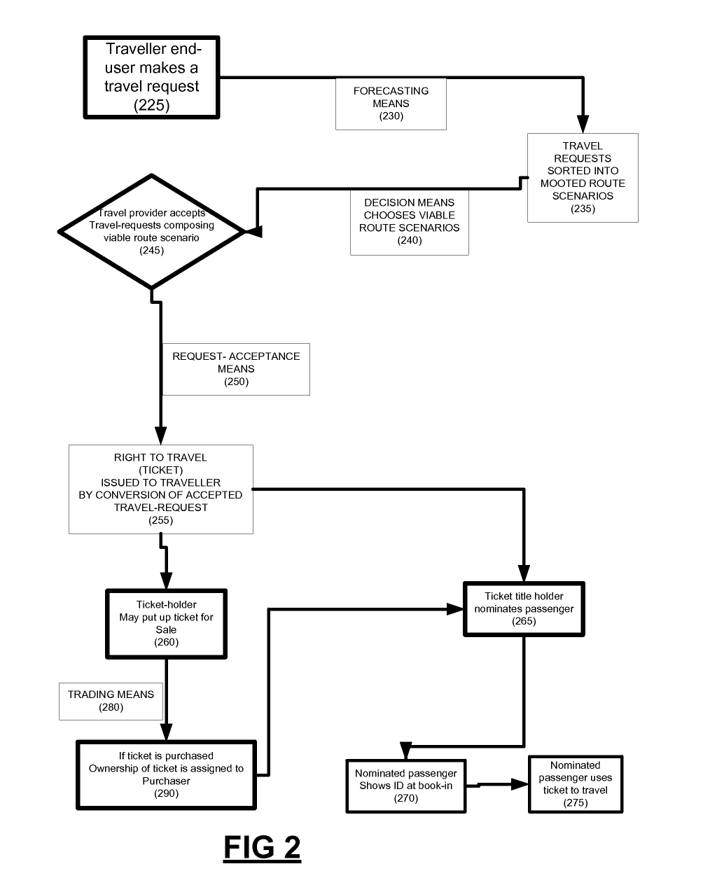

The travel requests webpage is a first forecasting means shown symbolically in box 230 of FIG. 2. The travel requests webpage advises the traveller E that she may make an offer, to purchase travel with traveller-chosen price and travel criteria provided that the offer is binding. This binding offer means that the traveller E may only make offers that are secured by that offer amount in the traveller E's personal internal money account. Also the offer being binding means that should that offer be accepted by a travel provider, then that acceptance is final and the corresponding offer price is automatically deducted by the payments means from the traveller E's personal internal money account and paid over to the travel provider's account.

The travel requests webpage suggests that an offer to purchase travel that may be placed on any one of a many flights has more chance of being accepted than a less flexible request. The webpage also suggests that the higher priced offers are more likely to be accepted. The webpage suggests that any request be left up for offer for as long as possible to increase the chances of it being accepted. The webpage also guides that any requests accepted for a flight at least two months before the flight will be tradable on the website with other logged-in travellers. Accepted requests that are tradable may be bought and sold with other travellers on a ticket-sell-offers webpage, a first trading means, on the website of the travel forecasting and allocating system. It happens that the airlines that offer chartered flights require almost two months notice before any flight of a decision to charter any flight.

When making a travel request, on the travel request webpage, the traveller E may choose travel criteria from a number of travel dates including a range of dates; a number of days of the week; a number of time periods of the day; a number of departure airports and geographical regions; and a number of destination regions and airports. Also the traveller E may choose the service class of travel, must type in an offer price for the fare of the journey, and the passenger name or names if more than one passenger will travel together. The traveller E may also elect to link one or more travel requests as in the case when the traveller E will be dependent on a return flight should an away flight be accepted. Likewise the traveller E may also link requests on connecting flights.

Viewing FIG. 2 we can follow that a traveller end user is shown in legend box 225 making a travel request by using forecasting means shown in box 230. The traveller E makes an offer to purchase travel, or in other words a travel request, that suits her travel plans. So by using various drop-down menus on the travel request webpage, the traveller E makes a request to travel from Melbourne to Sydney for $70 anytime between 10^{th} October 2006 and 19^{th} October 2006 provided it is on a Monday, Tuesday, Thursday, or Friday. Once traveller E is satisfied she has entered all the necessary and correct information required, she posts this request across to a secure shopping cart on her registered traveller webpage. Her registered traveller webpage, a first exclusive means, is meant for her exclusive use for various actions relating to travel allocation.

The traveller E may leave her offer to purchase travel on the website indefinitely until she removes the request by again using the webpage. Alternatively, the traveller E needs to choose when the request will expire. The traveller E sets the request expiry date by typing in a date and time, which can be modified or cancelled later by the traveller E.

The traveller E's offer to purchase travel on the secure travel requests webpage is entered into a travel request register, by a first register means. The travel request is copied across to various flight queue lists in a flight list database. These lists are shown to travellers in many different flight queue list web pages.

Since the traveller E's request included flights between and including 10^{th} October and 19^{th} October excluding Wednesdays, Saturdays and Sundays; the traveller E's request is shown posted to a flight queue list webpage for a Tuesday 10^{th} flight, a flight queue list for a Thursday 12^{th} flight, a flight queue list for a Friday 13^{th} flight, a flight queue list for a Monday 16^{th} flight, a flight queue list for a Tuesday 17^{th} flight, and a flight queue list for a Thursday 19^{th} flight. For simplicity of explanation in this embodiment only one flight per day is available or and therefore there is only one flight queue list for each day.

Other likewise requests made by other travellers are shown posted to corresponding flight queue list web pages. Thus each such flight queue list webpage collects requests.

Thus a flight queue list is a queuing means, while its respective flight queue list webpage is a broadcasting means for other travellers to view requests.

Considering now the Tuesday 10^{th} October 2006 flight queue list webpage, the requests are listed from highest to lowest offer prices. Any traveller may access and view the Tuesday 10^{th} flight queue list by searching for and viewing the corresponding webpage. While the flight queue list shows an identifying number of each posted request and its price, it does not show any identities of travellers or passengers.

The various travel request offers in the travel request register are read, searched and processed by a number of decision means shown symbolically as legend box 240. The first decision means uses computing algorithms to decide which requests posted on the various flight queue lists will be economically acceptable to a travel provider.

For example the first decision means adds up the highest one hundred offers on the flight queue list for the 10^{th} October 2006, and gets a sum of $11500. The first decision means then compares the sum of offers against an entered price of $12000 offered by a charter airline for chartering of a flight of 100 passengers on 10^{th} October. Since the charter cost is higher than the sum of offers the first decision means does not accept this scenario as economically acceptable.

The first decision means also adds up the highest one hundred and fifty offers on the flight queue list for the 10^{th} October 2006, and gets a sum of $15500. The first decision means then compares the sum of $15500 against an entered cost price of $15000 offered by a charter airline for chartering a flight of 150 passengers on the 10^{th} October. Since the sum of offers is higher than the cost of chartering the flight the first decision means signals that this scenario is economically acceptable.

However the first decision means also processes other scenarios for the same flight queue list despite having found an economically acceptable scenario for that flight. For example the first decision means also tests the scenario of chartering a flight for 300 passengers on the 10^{th} October. Also the first decision means tests the scenario of more than one flight being chartered from the corresponding list of offers. In yet a further example the first decision means tests the economic acceptability of various scenarios of groups of flights, including of groups of flights on different days, including routes of flights.

After testing the economic acceptability of various scenarios, a second decision means extracts an optimum economically acceptable scenario or scenarios of collected travel demand from the flight queue list.

The optimum scenario is presented as a bundle of requests to travel providers for acceptance.

When making scenarios and deciding their economical viability, it is important that each request that may have been posted to more than one flight is only collected into one bundle of requests only. In other words the traveller must only be placed on one flight when the offer was to purchase only one flight, even though the traveller was flexible on when that flight took place.

A travel provider who is a charter airline decides to provide a flight carrying 150 passengers on the 10^{th} October 2006. Thus it accepts a bundle of 150 travel requests for the 10^{th} October 2006, using an acceptance means. This acceptance process is shown symbolically as box 245 while acceptance means are shown as box 250. In this case, the request of the traveller E was selected in the bundle of requests, so traveller E is placed on the flight on the 10^{th} October 2006.

A third communication, or notification means of the travel forecasting and allocating system is provided to automatically notify any registered traveller of a change of status of its travel requests, its money account, and its rights to travel. When registering, or at a later opportunity, each traveller selects its preferred medium or mediums of notification. Traveller E selects SMS (short text message service by mobile cell phone) and email notification.

The traveller E receives an automatic notification of an email and a mobile phone SMS that the charter airline has accepted her offer as a seat on the flight on the 10^{th} October 2006. The notification also states that the offered $70 has been deducted from the traveller E's personal internal money account by the payment means, to pay for the flight from Melbourne to Sydney.

A payment means deducts $70 from the traveller E's personal money account and posts it to an account of the charter airline.

Since traveller E's request has been accepted, all posted requests created by traveller E's request which appear on each of the flight queue lists for flights on the 10^{th}, 12^{th}, 13^{th}, 16^{th}, 17^{th}, and 19^{th} October, are now removed.

An acceptance means triggers a second registering means shown as box 255 in FIG. 2 to give title to traveller E to a specific right to travel for the 10^{th} October 2006 flight, right to travel number TR/Q134/2006Oct10/028. The traveller E is registered in a right to travel register list as the current title holder to right to travel TR/Q134/2006Oct10/028.

The traveller E may view the title on her registered traveller webpage. So the right to travel is for a place on a specific flight to and from specific airports, taking place at a specified date and time.

There is and can only be one title holder to each right to travel at any point in time. The title holder traveller of a specific right to travel may nominate and change nominations of the passenger for that right to travel. This is achieved by the traveller E logging onto her registered traveller webpage using her PIN and registered traveller code, and entering the corresponding passenger name and information in an appropriate place on the webpage, for that specific right to travel.

It happens that the travel plans of traveller E change. Traveller E will be unable to travel on 10^{th} October 2006. So traveller E decides to put up her right to travel TR/Q134/2006Oct10/028 for sale on the travel club website. Traveller E logs into the website and accesses her own traveller E registered traveller webpage which is not accessible to other website users. Right to travel TR/Q134/2006Oct10/028 is listed on traveller E registered traveller webpage. On the traveller E registered traveller webpage, traveller E authorises the offer of selling TR/Q134/2006Oct10/028 for $80. This trading offer process is shown as box 260 using the trading means of box 280.

Traveller E's offer to sell is copied to a ticket-sell-offers list. All offers to sell rights to travel are posted to a tickets-sell-offers list.

Traveller registered travellers of the public may create appropriate computerised searches on a search webpage of the website. One such search may yield a list of appropriate offers to sell, extracted from the tickets-sell-offers list, on a tickets-sell-offers webpage. A traveller may select a chosen right to travel from the tickets-sell-offers webpage for purchase.

For another traveller G to accept a ticket-sell-offer, or in other words buy an existing right to travel, the traveller G needs to first register with the travel club on the travel forecasting and allocating system. After registration traveller G will receive his own individual personal identification number (PIN) and his own individual registered traveller identification code. Traveller G's own PIN and registered traveller identification code must be provided by traveller G to enable the traveller G to make any transaction on the website.

A ticket-sell-offer is accessed by computer searching of the relevant list. Traveller G decides to accept a ticket-sell-offer of SO/TR/Q134/2006Oct10/028 using trading means 280. The offer to sell, SO/TR/Q134/2006Oct10/028, was made by traveller E. The right to travel TR/Q134/2006Oct10/028 is currently held by traveller E. However traveller G does not know who the holder of the right to travel is. To accept the ticket-sell-offer traveller G needs to first have sufficient funds i.e. $80 in his personal internal money account to pay for the right to travel. Traveller G then ensures that $80 is in traveller G's internal money account.

Traveller G decides to accept the offer which he has posted onto a shopping cart on his secure registered traveller webpage. After mouse clicking acceptance, $80 is transferred out of traveller G's personal internal account and paid into traveller E's internal account. Then title to the right to travel TR/Q134/2006Oct10/028 is removed from traveller E and given to traveller G, or in other words is transferred as shown in box 290. An automated SMS and email notification is promptly sent to traveller E explaining the acceptance of SO/TR/Q134/2006Oct10/028. The notifications mention the receipt of $80 into traveller E's account. Traveller E is not notified of the identity of the purchaser.

Also traveller G is likewise promptly notified that $80 has been paid out of his account to pay for TR/Q134/2006Oct10/028. The traveller G's registered traveller webpage now reflects that the title to TR/Q134/2006Oct10/028 belongs to traveller G. In other words the right to travel has been assigned to traveller G by traveller E. Traveller G is now the current unique holder of the right to travel TR/Q134/2006Oct10/028. The traveller E registered traveller webpage no longer reflects ownership of TR/Q134/2006Oct10/028.

Traveller G may in turn wish to offer any held rights to travel for sale. A right to travel may be traded many times over and in each trade the title ownership is transferred to the latest purchaser. But traveller G decides to allow his friend van der Merwe to use the right to travel. Traveller G accesses his registered traveller webpage as shown by box 265, and inserts ‘van der Merwe’ as the passenger for the right to travel TR/Q134/2006Oct10/028.

On the 9^{th} October 2006, twelve hours before the flight Q134 (10^{th} October 2006) takes place, further trading, including making of offers, of any rights to travel on Q134 is inhibited by a computerised first window period means.

On the 9^{th} October 2006 the charter airline is emailed a list of passenger names for the rights to travel it must service on the 10^{th} October 2006. After further trading is inhibited, an authorised employee of the charter company may access the passenger list of the rights to travel to which it is party, on a charter company registered traveller webpage. The relevant passenger list is only available for viewing on a charter airline registered traveller webpage on the 9^{th} October 2006. The relevant passenger list shows each right to travel number, the title holder identity of each right to travel, and the passenger name of each right to travel.

Also each traveller who is a title holder of a right to travel on the journey Q1342006Oct10 is notified with an emailed ticket for the flight. Simultaneously an SMS notifying the sending of an emailed ticket is sent to each title holder.

The passengers on the flight need to show their photo identity documents and/or emailed ticket to the check-in clerk of the charter airline when checking in as shown in boxes 270 and 275.

### A second example of a traveller and travel provider use of the travel forecasting and allocating system now follows to illustrate the application of put and call contract options on rights to travel.

Traveller G needs to attend to business from Feb. 24, 2006 in Cape Town. He is not yet sure whether he wants to return on March 9 or March 10. Traveller G is a registered traveller of a travel club of a travel forecasting and allocating system who has been issued with his own personal secret password and PIN. In early February, traveller G searches the web pages of a travel club website for suitable rights to travel and/or option-contracts. Traveller G finds and purchases a right to travel for February 23, a FlexiFlyer position for March 9, and another FlexiFlyer position for March 10 on the travel website from other end users who are anonymous to himself.

Right to travel FirmFlyer/X 567/2006Feb23/089 provides his evening flight to Cape Town. Traveller G has also purchased X777/2006Mar09/045/FlexiFlyer and X778/2006Mar10/011/FlexiFlyer positions within two separate OverBook option-contracts. This means that at a later stage traveller G may decide to use either of the two FlexiFlyer positions to purchase a return flight place. Strictly speaking, he may use both but in this instance he intends using only one of them.

He has paid $100 for FirmFlyerX567/2006Feb23/089. He has paid a consideration price of $20 for X777/2006Mar09/045/FlexiFlyer (or in other words has paid $20 for the option) and likewise $15 for X778/2006Mar10/011/FlexiFlyer. The right to travel purchase price for FirmFlyerX777/2006Mar09/045 is $110 with the holder of the other position FirmFlyer/X777/2006Mar09/045/RelinquishFlyer whose identity is anonymous to traveller G. The holder of FirmFlyer/X777/2006Mar09/045/RelinquishFlyer is paid and keeps the consideration price regardless of whether the option is exercised or not.

The right to travel price of FirmFlyerX778/2006Mar10/011 is $120 with the holder of the other position FirmFlyer/X778/2006Mar10/011/RelinquishFlyer whose identity is also unknown to traveller G.

Traveller G decides to ensure FirmFlyer/X567/2006Feb23/089 in case there is a change in his plans before the flight time. If his plans change so that he is unable to use the right to travel, an ensure option will ensure that he may sell the right to travel at a predetermined price.

On the travel forecasting and allocating system traveller G finds another party H willing to take a StandbyFlyer position on the FirmFlyer/X567/2006Feb23/089 at a purchase price of $100 for the payment of a consideration price of $25. This other party H, anonymous to traveller G, must have $100 frozen in its internal money account, to take this position. Traveller G now pays the consideration price of $25 for an EnsureFlyer position on FirmFlyer/X567/2006Feb23/089. The $25 is paid over to the other party H by payment means of the travel forecasting and allocating system. Traveller G is now the holder of FirmFlyer/X567/2006Feb23/089/EnsureFlyer.

If his plans for travel on the 23 February happen to change, he is certain of being able to sell FirmFlyer/X567/2006Feb23/089 for $100 provided he does this in the exercise period of FirmFlyer/X567/2006Feb23/089/EnsureFlyer which in this instance expires 2 days before 23 Feb. 2006. Ensuring that he can sell his right to travel at $100, cost him $25 in this instance. (This cost was whether or not he exercises his right to sell). It so happens that traveller G uses the FirmFlyer/X567/2006Feb23/089 right to travel to fly to Cape Town.

Traveller G must decide whether to exercise his FlexiFlyer rights to purchase before they expire. On 1^{st} Mar. 2006 he decides to purchase FirmFlyer/X777/2006Mar09/045 for $110 by exercising his right from holding X777/2006Mar09/045/FlexiFlyer. He enters a secure transactions registered traveller web page on the travel forecasting and allocating system using his own secret registered traveller password and PIN, making the purchase of FirmFlyer/X777/2006Mar09/045 from the anonymous holder J of FirmFlyer/X777/2006Mar09/045/ReliquishFlyer for $110.

The anonymous previous holder J of FirmFlyer/X777/2006Mar09/045/ReliquishFlyer receives an e-mail and SMS informing s/he that s/he have been paid $110 for FirmFlyer/X777/2006Mar09/045 by exercise of purchase right by holder of X777/2006Mar09/045/FlexiFlyer.

Traveller G will use FirmFlyer/X777/2006Mar09/045 to return from Cape Town. So traveller G decides to offer X778/2006Mar10/011/FlexiFlyer for $5 on the travel forecasting and allocating system. After Mar. 8, 2006, X778/2006Mar10/011/FlexiFlyer will expire and no longer exist, so only travellers who will immediately take up the exercise right to purchase FirmFlyerX778/2006Mar10/11 at $120 are likely to purchase this FlexiFlyer position.

A third example of traveller entity and travel provider use of present invention now follows:

### Registration Procedure

A company K submits an application to register as a registered traveller on a secure registration webpage, a first identification means. The application to register concerns the company K particulars. The managing director of the company K signs an agreement to the rules of association of a travel club which controls the travel forecasting and allocating system, and couriers an original signed document and faxes another through to its management. The company K's registration form includes the nomination of a manager T responsible for travel of employees as an authorized user of the travel forecasting and allocating system. The travel manager T's personal information such as identification and addresses is entered into the travel forecasting and allocating system registered traveller database, of the first identification means.

The company K's application is accepted by the management of the travel club, and thus joins the travel club and pays a membership fee. Now company K is a registered traveller with the travel forecasting and allocating system. The travel forecasting and allocating system automatically emails a generated password to the company K address. By known state of the art second and third identification means the travel manager T receives a secret password and PIN from the travel forecasting and allocating system.

### Travel Request Process

A first forecasting means allows travellers to make committed offers for rights to travel on journeys that they expect to use. The committed offer is called a travel request. A travel request webpage has various drop-down menu boxes so that each traveller may make different choices and accordingly create a request in the form of an offer to purchase travel that suits the traveller. An example of a travel request webpage follows:

THIS IS COMPANY K TRAVEL REQUEST PAGE
REGISTERED TRAVELLER NUMBER: K
This is Request number: 1234567890
Travel criteria for single term request (once off request)
Fare offer Price including Taxes and fees□
Number of passengers together on journey□
Departure□ (drop-down choices not shown)
Destination□ (drop-down choices not shown)
(Time period of day)□ (drop-down choices not shown)
OR
(Flight schedule number)□ (drop-down choices not shown)
Day of week (e.g. drops down to:)

Monday□
Tuesday□
Wednesday□
Thursday□
Friday□
Saturday□
Sunday□

Date (calendar in Week number and months) □ (drop-down choices
not shown)
Service class □ (drop-down choices not shown)
Linking of different requests
Return flight □
Connecting flight □

It is possible to make more than one choice in some of the criteria menu boxes. For example a request may be made for a flight on EITHER a Monday or Thursday. Then a traveller checks BOTH Monday and Thursday boxes drawn out (dropped down) of the ‘day of week’ menu. Similar possible choices apply for flight times, flight numbers, flight dates, and the optional choice of airline. The possibility of traveller's flexibility on journey criteria is thus recorded.

Travellers may benefit from such flexibility by being placed (accepted) at a lower than otherwise fare. An airline may benefit by moving demand from peaks to troughs to minimise numbers of flights for same demand.

Now in this example, the company K decides to make a weekly-series request to purchase for one year, a right to travel for every Tuesday morning on flight XYZ to fly one person in business class from A to B.

The number of this travel request, registered in the travel system is ForwardOffer/XYZ/2005Feb08/001/1W/1/2006Feb07/001. This request automatically creates corresponding 52 individual requests to make it easy for regular users to make many requests in one. A second forecasting means is what makes this series of requests possible.

The request ForwardOffer/XYZ/2005Feb08/001/1W/1/2006Feb07/001 made by company K automatically issues an offer for each of a series of rights to travel on flight XYZ, by the second forecasting means.

The first of the series of rights to travel is on the 8 Feb. 2005; the first offer ForecastOffer/XYZ/2005Feb08/001, first of the series of offers for rights to travel, is automatically issued/offered four weeks before 8 Feb. 2005. The second request is made a week later, four weeks before the next flight of the series of offers for rights to travel.

Company K also makes a similar weekly series request to purchase for the same year period, a right to travel for every Thursday evening flight on flight ZYX to fly one person on economy class back from B to A. This is a second group of 52 requests intended for return flights for a company K employee who usually travels away on a Tuesday to return on a Thursday. The number of this second request registered by company K on the travel forecasting and allocating system is ForwardOffer/ZYX/2005Feb10/004/1W/1/2006Feb09/004.

Company K makes these requests to purchase in late 2004. The ease of making one request for a series of flights however means that if company K wants to remove a request it will have to take off the whole series of requests as one.

Generally the company K is not too concerned whether it will use all the rights to travel for which it made offers, since it may trade unwanted rights to travel so easily. To make a series request company K moves to a series request webpage and fills it in thus (entries of this example are shown in brackets after box [symbol] ):

An example of a webpage for series requests follows:

THIS IS COMPANY K TRAVEL REQUEST PAGE
REGISTERED TRAVELLER NUMBER: C
This is Request number: ####
Travel criteria for series term request (requests for journeys repeating
at regular intervals)
Fare offer Price (for each passenger) including Taxes and fees□ $(D)
Number of passengers together on journey□ (1)
Departure□ (A)
Destination□ (B)
(Time period of day)□
OR
(Flight schedule number)□ (XYZ)
Day of week (e.g. drops down to:)

Monday□
Tuesday□ (#)
Wednesday□
Thursday□
Friday□
Saturday□
Sunday□

Date of first flight in series (calendar in Week number and months) □
(week6/2005)
Service class (all passengers together) □ (business)
Airline (optional entry) □ (X)
Number of repeat requests (terms) in series of requests □ (52)
One-week period between repeat requests□ (#)
Two-week period between repeat requests□
Four-week period between repeat requests□
Period in weeks, before each flight, of each request's auto-issue □
(4 weeks)
Period in weeks, before each flight, of each request's auto-removal □
(2 weeks)
Linking of different requests
Return flight □ (ForwardOffer/ZYX/2005Feb10/004/1W/1/2006Feb09/
004)
Connecting flight □
CONFIRM REQUEST □
...........................................................

After confirming this request the web site opens a confirmation procedure on a registered traveller's webpage. The registered traveller K's webpage looks like this:

REGISTERED TRAVELLER INFORMATION
ADDRESSES:

Residence:
Office:
Legal:

IDENTITY:

Name:
Company registration details:
Passport details:
Date of birth:
Social security number:

BANKING INFORMATION:

For payables bank details:
For receivables bank details:
Credit card details:

PORTAL MEMBERSHIP INFORMATION:

Membership number:
Rules of association agreed to:

AUTHORIZED USER INFORMATION:

Membership number:
Membership number:

Travel requests awaiting
confirmation:
ForwardOffer/XYZ/2005Feb08/001/1W/1/2006Feb07/001
ForecastOffer/XYZ/2005Feb08/001
ForecastOffer/XYZ/2005Feb15/001
ForecastOffer/XYZ/2005Feb22/001
ForecastOffer/XYZ/2005Mar01/001
ForecastOffer/XYZ/2005Mar08/001
ForecastOffer/XYZ/2005Mar15/001
ForecastOffer/XYZ/2005Mar22/001
ForecastOffer/XYZ/2005Mar29/001
ForecastOffer/XYZ/2005Apr05/001
ForecastOffer/XYZ/2005Apr12/001
ForecastOffer/XYZ/2005Apr19/001
ForecastOffer/XYZ/2005Apr26/001
ForecastOffer/XYZ/2005May03/001
ForecastOffer/XYZ/2005May10/001
ForecastOffer/XYZ/2005May17/001
ForecastOffer/XYZ/2005May24/001
ForecastOffer/XYZ/2005May31/001
ForecastOffer/XYZ/2005Jun07/001
.....ET CETERA (not shown in this example).........
ForecastOffer/XYZ/2006Feb07/001
Generated from ###
CONFIRM ALL□
Binding Travel requests made:
ForwardOffer/ZYX/2005Feb10/004/1W/1/2006Feb09/004
ForwardOffer/X123/2006Jan02/077/1W/2/2006Jan09/078
ForwardOffer/X321/2006Jan02/096/1W/1/2006Jan09/096
Rights to Travel held:

FirmFlyer/X123/2006Jan02/077
FirmFlyer/X123/2006Jan02/078
FirmFlyer/X321/2006Jan02/096
FirmFlyer/U322/2006Jan03/022
U322/2006Jan09/145/FlexiFlyer

............

Any registered traveller end user may make offers for rights to travel by clicking flight time and date boxes, filling in departure and destination criteria boxes, filling in service class criteria boxes, and filling in fare price, on a travel request webpage. The travel manager T is the designated person, authorized by company K, recorded as such within the first identification means, who accesses the secure web pages to make the requests.

Traveller T enters a secure registered traveller web page, a first exclusive means, by fourth identification means of logging in her password and PIN identification codes, which are third identification means. Then a travel request is made by clicking at an acceptance block on the secure registered traveller web page.

Company K is already registered with the travel forecasting and allocating system, and company K's bank account is linked to the travel forecasting and allocating system, by a payment means. Company K has agreed to terms and conditions and legal procedures of any rights to travel made on the travel forecasting and allocating system when it joined the travel club and signed the rules of association.

Once a right to travel is paid for it issues as an independent contract in which company K the purchaser, is its holder. Each right to travel is irrevocable and binding. The holder of a right to travel is not able to change reservations or cancel or get a refund with the airline, the other party to this contract. However, the right to travel holder normally will be able to sell this right to travel by a first trading means on the travel forecasting and allocating system; which more than compensates the holder from not being able to cancel or change reservations.

Any other authorized user of company K may log on and enter company K's registered traveller web page. This web page is not accessible to other users of the Internet. A registered traveller web page shows the authorized user the current registration information, which includes company K addresses, identity particulars, company K authorized user information, and linked company K bank account information. Also, the company K's registered traveller web page shows register numbers of the rights to travel held by company K. A status of each travel request is shown in a drop down list.

An information section of each registered traveller's webpage shows whether or not any right to travel is on offer for purchase, whether or not it has been purchased and thus issued, whether or not company K currently offers it for sale on the travel forecasting and allocating system, or whether or not it has attached option-contracts. Clicking on a right to travel number in this drop down list will open up all any available detailed information on that right to travel, which includes flight times and service class, any restrictions on trading and option making rights. Obviously, many various travel forecasting and allocating requests, and rights to travel may be registered to any one registered traveller of the travel forecasting and allocating system.

### Travel Request Acceptance

A third communication means notifies company K by email once any travel request is accepted by an airline company. In this example, a request is accepted as part of a bundle of requests by an airline operating an acceptance means. Then a second registering means automatically issues a right to travel, number FirmFlyer/XYZ/2005Feb08/001, for the Tuesday flight XYZ week 6, 2005. This happens upon confirmation of the $D transferred. FirmFlyer/XYZ/2005Feb08/001 is issued by the second registering means to company K, with the holder recorded within its database of company K, and also within its register of rights to travel.

Company K need not fetch or print a ticket as a drop down of the ‘rights to travel held’ in company K's secure registered traveller's webpage shows that FirmFlyer/XYZ/2005Feb08/001 has been paid for and issued. The prefix ‘FirmFlyer’ shows that it is an issued right to travel. However, company K should designate a passenger who will fly, using a nomination means. By default of nomination, the nomination means enters the travel manager T of company K who authorized the travel request, as the passenger.

The authorized user, the travel manager T of company K, reads a respective right to travel register linked from company K registered traveller webpage, and nominates an employee L of the company K as the passenger of FirmFlyer/XYZ/2005Feb08/001 and FirmFlyer/ZYX/2005Feb10/004. The designated passenger, employee L is a registered traveller of the travel club. This means that employee L's personal details have been previously entered into the travel forecasting and allocating system database and that he has received a travel club registered traveller card prior to and independently of this passenger nomination. Employee L was keen to be a registered traveller to receive special treatment at check-in.

### Passenger Use of Right to Travel

At check-in on Tuesday morning of week 6, 2005 employee L shows his photo ID or his travel club membership card to a check-in clerk of airline X, who checks his ID as that matching the identity, designated by a flight passenger list generated from the right to travel register, as the passenger of a right to travel FirmFlyer/XYZ/2005Feb08/001, and issues him with a boarding pass.

Normal flying procedures now follow. Employee L returns on Thursday on flight ZYX, when claiming another right to travel FirmFlyer/ZYX/2005Feb10/004, also using the same travel club membership card to check in, although he is flying on a different airline Z.

On Tuesday week 3, 2005, because of the series travel request ForwardOffer/XYZ/2005Feb08/001/1W/1/2006Feb07/001 made, another travel request ForecastOffer/XYZ/2005Feb15/001 for week 7 Tuesday, number is automatically issued by the travel forecasting and allocating system, on behalf of company K.

Since company K specified airline X and flight XYZ the offer must be made to airline X. The airline only accepts the offer if the offer price combined with other offers which queue into flight XYZ/2005Feb15 X add up to an amount sufficient to profitably service the flight. In other words the offer is accepted as a bundle of requests.

It happens that airline X accepts the offer in week 4 2005 as part of a bundle of requests. The right to travel FirmFlyer/XYZ/2005Feb15/001 is then issued to company K upon automatic payment by the trading means.

### Change of Passenger Name on a Right to Travel

Company K then designates employee P as the passenger of FirmFlyer/XYZ/2005Feb15/001. Like the previously described right to travel use, employee P uses this right to travel on the Tuesday of week 7, 2005; employee P is also a registered traveller of the travel club.

The travel manager T of company K designates employee L, to use the right to travel FirmFlyer/XYZ/2005Feb22/001 which is later issued to company K, for the Tuesday flight XYZ of week 8, 2005. But, on the Tuesday morning of week 8, before check-in time, employee L calls in that he is ill and cannot fly.

Then the travel manager T moves the name of the passenger of this same FirmFlyer/XYZ/2005Feb22/001 to that of employee P, by using the nomination means on the Internet with the password and PIN codes that only she holds.

Thus employee P is able to check in for the Tuesday flight XYZ of week 8. The check-in clerk will only see that employee P is eligible to use that FirmFlyer/XYZ/2005Feb22/001 as a passenger, when viewing the relevant web page of the passenger list. The check-in clerk cannot change the passenger information nor does the check-in clerk see the history of change of passenger. Travel forecasting and allocating system end users, other than the service providing airline, cannot view the passenger information.

### Offer to Sell Rights to Travel (Trading of Right to Travel)

Since the Tuesday of week 9 is a public holiday, company K will not send any employee to point B. However, it has automatically purchased a right to travel FirmFlyer/XYZ/2005Mar01/001 for the Tuesday flight XYZ of week 9 when the respective offer was accepted.

After Tuesday week 5, when the week 9 right to travel is issued, the travel manager T logs onto the company K registered traveller webpage via the Internet and puts up FirmFlyer/XYZ/2005Mar01/001 contract for sale on a ticket-sell-offers list, for $1.1D.

She also searches for a right to travel for Wednesday flight XYZ week 9 2005 or similar. Such a right to travel for $0.9D, FirmFlyer/UVW/2005Mar02/067 is found offered on a ticket-sell-offers webpage, which shows search results from the ticket-sell-list.

An anonymous traveller, the holder of FirmFlyer/UVW/2005Mar02/067, has put up the right to travel for sale at $0.9D. The travel manager T finds the offer to sell FirmFlyer/UVW/2005Mar02/067 on a ticket-sell-offers webpage, imports FirmFlyer/UVW/2005Mar02/067 to a shopping cart on company K's secure registered travellers webpage. Then travel manager T purchases the right to travel by clicking the computer mouse at the acceptance block, on the secure transactions registered traveller web page, for that contract.

This sets off automatic payment means of $0.9D from company K's bank account to registered traveller M's bank account, the current owner, or holder of the right to travel FirmFlyer/UVW/2005Mar02/067.

### Change of Ownership Title to a Right to Travel

Now, after payment, FirmFlyer/UVW/2005Mar02/067 is automatically transferred by the trading means, and registered as belonging to company K and no longer owned by registered traveller M. The trading means records the registered holder of this right to travel as company K in its rights to travel contracts register. The right to travel register, a second registering means, is a master record of all rights to travel and options on rights to travel. There can only be a single registered holder of any contract at any point in time.

Then likewise, the travel manager nominates, by using the nomination means in the company's registered traveller webpage, an employee to use the FirmFlyer/UVW/2005Mar02/067 right to travel on Wednesday. Later in week 6, 2005, the travel manager of company K receives an e-mail automatically generated by the third communications to inform her that FirmFlyer/XYZ/2005Mar01/001 has been sold for $1.1D.

This sale happens after a user of the travel forecasting and allocating system accepted the price and the automatic payments by the payments means have been subsequently made. The new owner of the right to travel FirmFlyer/XYZ/2005Mar01/001 on the public holiday is not shown to company K by the travel forecasting and allocating system.

### Use of Purchased Right to Travel by Another Traveller

Registered traveller M is a pensioner, registered with the travel forecasting and allocating system, who is the holder of a series request which offers to purchase rights to travel for Wednesday morning flights UVW for transport from A to B by airline U for every fourth week of the years 2005 and 2006.

Registered traveller M generally visits her daughter every fourth week. Her daughter fetches her at the point B. Registered traveller M made the offer at a lower price of $0.6D for Wednesday flights rights to travel. Airline U accepts these rights to travel for a low price because they need extra paying passengers on Wednesday.

It so happens that because of the public holiday, Registered traveller M's daughter was to go away for the week. This is what prompted registered traveller M to approach her travel agent, to put the right to travel for the day following the public holiday, up for sale. Since registered traveller M was not confident using the computer, she used the services of her travel agent. Registered traveller M showed the travel agent her travel club photo ID membership card and presented her thumb for reading by the biometric laser reader at a travel agent office. Thus, she gave her authority to the travel agent to sell her right to travel FirmFlyer/UVW/2005Mar02/067 to the Wednesday flight. With registered traveller M agreeing to sell at any price, the travel agent then connected the sale to a computer program algorithm which would progressively offer FirmFlyer/UVW/2005Mar02/067 at a reducing price.

A SMS is sent to registered traveller M's daughter to inform of the sale of FirmFlyer/UVW/2005Mar02/067 for $0.9D, who then informs her mother in turn by phone. The SMS was directed to registered traveller M's daughter automatically by the third communication means, since this is the contact means entered by registered traveller M upon initial registration to the travel club. Neither registered traveller M nor her travel agent are shown by the travel forecasting and allocating system that it is company K who has purchased the right to travel from registered traveller M.

### Accepting Offers to Buy Rights to Travel (Trading of Right to Travel)

During the month of December, the clients of company K close down their factory, and company K does not need to send down a representative to point B. Company K needs to dispose of all December rights to travel from point A to point B, and from point B to point A, in advance.

It happens that the December rights to travel then get issued, are accepted by an airline, and then get registered on the right to travel register of the travel forecasting and allocating system. The travel manager T does not bother with passenger nomination, and immediately sets out to sell these rights to travel by the trading means of the travel forecasting and allocating system to travellers who are making corresponding travel requests.

The travel manager T intends selling the December rights to travel directly to registered traveller users who are making travel requests.

Travel manager T searches flight queue list web pages to find travel requests with travel criteria that match each of the December rights to travel that are held by company K. For each of the December rights to travel, travel manager T finds a highest priced matching travel request and imports it to company K's registered traveller webpage. Then by following acceptance procedures on the secure webpage, traveller T authorises acceptance of each corresponding travel request.

So in effect, company K uses an existing travel commitment to accept a travel request, rather than an airline accepting a bundle of requests. Effectively company K becomes a travel provider.

### Selling Options on Rights to Travel

For some of the other company K held December rights to travel, the travel manager T buys EnsureFlyer positions with other registered travellers. Company K offers, for the held December rights to travel, to pay a consideration of $0.25D each, to other parties, for each of them to take a StandbyFlyer position to purchase a right to travel for $D.

A registered traveller user Q accepts such a StandbyFlyer position and receives $0.25D for taking this position. Thus, a NoShow option-contract has been made between company K and registered traveller Q for right to travel FirmFlyer/ZYX/2005Dec15/004 by using options means of the travel forecasting and allocating system.

Registered traveller Q searched for and found and accepted this StandbyFlyer position within a NoShow option-contract by using a third search means. Registered traveller Q is flexible on the time when travelling, so by taking this position she has now effectively reduced her travel price to $0.75D, being the difference between $D and $0.25D.

$0.25D is received by registered traveller Q at the time of making the option-contract, regardless of whether she is sold the right to travel at a later stage or not. Registered traveller Q now becomes the holder of option-contract ZYX/2005Dec15/004/StandbyFlyer which is an obligation to the holder of FirmFlyer/ZYX/2005Dec15/004/EnsureFlyer, company K.

Company K on the other hand, after taking the EnsureFlyer position with registered traveller Q, still puts up the same right to travel FirmFlyer/ZYX/2005Dec15/004/EnsureFlyer for sale on a second trading means for $3D. If the company K sells the right to travel, with the attached option, for anything above $1.25 D, it will make a profit. If it cannot sell it to anyone else, it can force the sale (exercise its EnsureFlyer option) with registered traveller Q, hedging its loss to the $0.25D that it had paid to registered traveller Q.

Company K may at anytime during the exercise period of the NoShow option-contract exercise its EnsureFlyer right to sell the underlying right to travel to registered traveller Q for $D. Since the EnsureFlyer position is dependent on holding the underlying right to travel, and this position is thus attached to the underlying right to travel, the identifying number of the right to travel now reflects this by having the EnsureFlyer name tacked onto the end of the number thus FirmFlyer/ZYX/2005Dec15/004/EnsureFlyer.

The holder of this right to travel is then the holder of the EnsureFlyer right for that right to travel too. If the right to travel FirmFlyer/ZYX/2005Dec15/004/EnsureFlyer is sold to another registered traveller, it is sold, transferred and assigned intact with its first contractual right for transport on the flight ZYX on the 15 Dec. 2005, its second contractual right to be resold, and its third contractual right to exercise an option as made with the holder of ZYX/2005Dec15/004/StandbyFlyer.

This concludes three examples of traveller and travel provider use of the present invention.

### DETAILED DESCRIPTION OF TRAVEL REQUESTS ALLOCATION PROCESS OF THE PRESENT INVENTION

After many travellers have posted many various travel requests, a first decision means continually tests various scenarios of accepting bundles of the various travel requests made on the travel forecasting and allocating system to find whether or not any scenarios are economically suitable. A simple example now follows to illustrate this decision process.

First all possible flights that are mooted by a travel provider are considered. In this example the travel provider is a travel merchant who charters aircraft journeys on behalf of travellers.

This example has only the resources of two aircraft for flights between points A and B. Only morning and afternoon flights are mooted.

Mooted flights for two available aircraft:

^{m}120_{AB} represents a morning (m) flight by a 120 seating aircraft from point A to point B.

^{m}120_{BA} represents a morning (m) flight by a 120 seating aircraft from point B to point A.

^{m}160_{AB} represents a morning (m) flight by a 160 seating aircraft from point A to point B.

^{m}160_{BA} represents a morning (m) flight by a 160 seating aircraft from point B to point A.

^{a}120_{AB} represents an afternoon (a) flight by a 120 seating aircraft from point A to point B.

^{a}120_{BA} represents an afternoon (a) flight by a 120 seating aircraft from point B to point A.

^{a}160_{AB} represents an afternoon (a) flight by a 160 seating aircraft from point A to point B.

^{a}160_{BA} represents an afternoon (a) flight by a 160 seating aircraft from point B to point A.

The 120 seating aircraft belongs to airline X while the 160 seating aircraft could be provided by airline Y if available. Each airline is only agreeable to hiring out their aircraft in units of round daily trips that return back where they started.

### Possible mooted daily round trips that originate at point A and return to B:

^{m}120_{AB}+^{m}120_{BA};

^{a}120_{AB}+^{a}120_{BA};

^{m}120_{AB}+^{a}120_{BA};

^{m}160_{AB}+^{m}160_{BA};

^{a}160_{AB}+a160_{BA};

^{m}160_{AB}+^{a}160_{BA};

Various mooted daily routes may be formed of combinations of daily round trips.

Mooted routes for each day: (must be composed of round trips; a flight may not double in a route)

1^{st} route: ^{m}120_{AB}+^{m}120_{BA}

2^{nd} route: ^{m}120_{AB}+^{m}120_{BA}+^{a}120_{AB}+^{a}120_{BA}

3^{rd} route: ^{m}120_{AB}+^{m}120_{BA}+^{m}160_{AB}+^{m}160_{BA}

4^{th} route: ^{m}120_{AB}+^{m}120_{BA}+^{a}160_{AB}+^{a}160_{BA}

5^{th} route: ^{m}160_{AB}+^{m}120_{AB}+^{m}120_{BA}+^{a}160_{BA}

6^{th} route: ^{a}120_{AB}+^{a}120_{BA}

7^{th} route: ^{m}160_{AB}+^{m}160_{BA}+^{a}120_{AB}+^{a}120_{BA}

8^{th} route: ^{a}120_{AB}+^{a}120_{BA}+^{a}160_{AB}+^{a}160_{BA}

9^{th} route: ^{m}160_{AB}+^{a}120_{AB}+^{a}120_{BA}+^{a}160_{BA}

10^{th} route: ^{m}120_{AB}+^{a}120_{BA}

11^{th} route: ^{m}120_{AB}+^{m}160_{AB}+^{m}160_{BA}+^{a}120_{BA}

12^{th} route: ^{m}120_{AB}+^{a}120_{BA}+^{a}160_{AB}+^{a}160_{BA}

13^{th} route: ^{m}120_{AB}+^{m}160_{AB}+^{a}120_{BA}+^{a}160_{BA}

14^{th} route: ^{m}160_{AB}+^{m}160_{BA}

15^{th} route: ^{m}160_{AB}+^{m}160_{BA}+^{a}160_{AB}+^{a}160_{BA}

16^{th} route: ^{a}160_{AB}+^{a}160_{BA}

17^{th} route: ^{m}160_{AB}+^{a}160_{BA}

18^{th} route: ^{m}120_{AB}+^{m}120_{BA}+^{m}160_{AB}+^{m}160_{BA}+^{a}120_{AB}+^{a}120_{BA}

19^{th} route: ^{m}120_{AB}+^{m}120_{BA}+^{a}120_{AB}+^{a}120_{BA}+^{a}160_{AB}+^{a}160_{BA}

20^{th} route: ^{m}120_{AB}+^{m}120_{BA}+^{m}160_{AB}+^{a}120_{AB}+^{a}120_{BA}+^{a}160_{BA}

21^{st} route: ^{m}120_{AB}+^{m}120_{BA}+^{m}160_{AB}+^{m}160_{BA}+^{a}160_{AB}+^{a}160_{BA}

22^{nd} route: ^{m}120_{AB}+^{a}120_{BA}+^{m}160_{AB}+^{m}160_{BA}+^{a}160_{AB}+^{a}160_{BA}

22^{nd} route: ^{m}160_{AB}+^{m}160_{BA}+^{a}160_{AB}+^{a}160_{BA}+^{a}120_{AB}+^{a}120_{BA}

23^{rd} route: ^{m}120_{AB}+^{m}120_{BA}+^{m}160_{AB}+^{m}160_{BA}+^{a}160_{AB}+^{a}160_{BA}+^{a}120_{AB}+^{a}120_{BA}

Each route is assigned a minimum cost price by the travel provider by external data entry into the first decision means.

A route scenario is a group, collection, or bundle of travel requests that are applicable to a mooted route. For purposes of illustration, a route scenario is related to requests or traveller demand, while a mooted route is related to travel supply.

A route scenario is comprised of a number of scenario queues of different flights. A scenario queue is a conceptual queue made up of a list of a number of travel requests, where all of the requests have common criteria relating to a mooted flight; the number of travel requests in the list of the scenario queue is limited to the number of available passenger places on the mooted flight.

So a number of travel requests make up a number of scenario queues which in turn make up a route scenario. A channeling mechanism is provided to decide which requests may form part of a route scenario. A scenario channeling mechanism is created for each mooted route by selecting matching criteria of mooted flights which compose a mooted route. For example 17^{th} route ^{m}160_{AB}+^{a}160_{BA} is comprised of the two flights ^{m}160_{AB} and flight ^{a}160_{BA}. So flight criteria of these two flights are used to form the scenario channeling mechanism's matching criteria.

Every so often, after completion of a previous processing cycle, a new processing cycle tests each existing request for entrance into each route scenario.

The following then applies for one processing cycle:

So for a request to enter into the 17^{th} route scenario for date 2006-10-31, it must match the following matching criteria:

### Date 2006-10-31

### AND

Time period: m

### AND

### Departure: A

### AND

### Destination: B

### If all three criteria match—Then enter flight ^{m}160_{AB} queue of scenario 17.

### IF NOT entered; then match

### Date 2006-10-31

### AND

Time period: a

### AND

### Departure: B

### AND

### Destination: A

### If all three criteria match—Then enter flight ^{a}160_{BA} queue of scenario 17.

So a route scenario consists of a number of scenario queues. While a flight may be found in more than one scenario, it does not follow that a scenario queue in one scenario will be composed of the same requests as a scenario queue of the same flight in another route scenario.

So a request must be tested into a route scenario rather than a scenario queue (regardless that the route scenario is made up of scenario queues) to avoid being placed more than once in any route scenario. For example a request may be placed into a scenario queue in one route scenario while being placed in another scenario queue in another route scenario.

Each travel request must be tested once, and once only, for entrance into each route scenario. So in this example each offer is tested for entrance into each of the 23 different route scenarios, once and only once, in each processing cycle.

No request may enter more than once into any route scenario in each processing cycle.

A request may enter into more than one route scenario.

The number of places in a scenario queue (its length) corresponds to the number of seats on a corresponding mooted flight.

Furthermore in each scenario queue (within a route scenario) a travel request's offered fare price must be higher than at least one fare price of another offer already in the queue. If there is an empty place in the queue then the offer is higher than nothing and so may enter regardless.

Preferably requests are queued in order of fare price. An outside request enters in front of highest offer in queue which is lower than the outside offer.

If an entered fare price offer is higher than another queued offer, and the queue to be entered is full, then the lowest priced offer in the queue is removed (bumped) from the queue, while the higher priced offer enters in the queue.

If an offer is removed (bumped) out of a scenario queue, that offer must be re-tested for entry into all other scenario queues of the same route scenario it was in.

The processing cycle ends when all travel requests were tested once for entrance into each scenario, and all bumped requests have been tested until no further bumping takes place in all route scenarios.

### Summation of Fare Offers in a Route Scenario

After a processing cycle of scenario queue formations ends, all offer fare prices of all scenario queues of each route scenario are added up together to give a scenario offer price. So there will be 23 different scenario offer prices for 23 different route scenarios after each processing round.

Each scenario offer price is compared to its minimum cost price.

If a scenario offer price is greater than the minimum cost price of the corresponding mooted route, a signal is sent to list in the bundling decision means to show a possible scenario bundle for acceptance by a travel provider/airline.

Therefore, after each processing cycle, the scenario offer price of each mooted route is likely to change. All changes of each scenario offer price, which has a possibility for acceptance, is tracked by a graph having time and price coordinates.

A maxima finding mechanism tracks the rate of change of the scenario offer price; and sends a further signal when the scenario price is levelling after having steadily grown. This is a still stronger signal to a travel provider to accept all the offers in that queue.

Incidentally, since many requests may appear in more than one route scenario, the travel provider must take into account which route scenario is best, and cannot accept more than one route scenario at any point in time (until the next processing cycle when any accepted offers will have been removed).

In other embodiments more complex routes, for example weekly routes, may be mooted of more mooted flights.

Once a route scenario is agreeable to the travel provider, and all comprising mooted flights may be put to service, the travel provider decides to accept the bundle of travel requests which comprise the route scenario.

The processes of travel request acceptance described previously in traveller examples take place when the bundle of travel requests is accepted by the travel provider.

### CONCLUSION

So persons and entities interested in purchasing travel services may post binding offers to purchase travel on journeys using the present invention. Such requests provide valuable information for a travel provider using the present invention. The valuable information includes: what the traveller is willing to pay, when and where the traveller wants to travel, and how flexible each traveller's requirements are.

When the information is for future travel that is mooted and may yet be decided, then that information can be used by a travel provider to decide whether to commit to providing a service to meet the future corresponding travel demand requests.

This process of using the present invention can be used intelligently to match travel supply with demand; rather than by the prior art method of matching demand to scheduled supply.

Not only does the invention provide methods for travellers to forecast their own travel demand, it also provides travellers with means to exploit incentives. When travellers exploit incentives they are efficiently allocating their travel requirements amongst themselves.

Incentives also help travellers to commit to purchasing travel sooner than they would otherwise do; the incentives minimise the impact to a traveller of its commitment. Incentives may comprise the following: a traveller paying a price of choice, receiving transferability and tradability to his purchased right to travel, receiving choices to taking options on his right to travel, being able to make passenger name changes, being able to pay for travel in installments, and being able to pay later after a travel purchase decision.

Travellers holding tradable, transferable rights to travel have the benefits of effectively changing their reservations with other travellers, and may profit from trading or otherwise reduce their risk of not being able to use a right to travel. Then the invention provides travellers with a hedging mechanism for their travel commitments. PCT/IB2006/05/1110 or WO2006/109248 titled ‘Travel system and method’ explains in more detail these benefits and possibilities of trading of rights to travel.

Also the invention makes it possible for travel providers to intelligently place a traveller's demand so as to economically suit the travel providers, rather than leaving a traveller who has flexible travel plans to place himself on any journey. In this way where an airline places a traveller in a manner which is economical to the airline, the airline may be able to level out peaks and troughs of demand.

An airline travel provider has an opportunity of having traveller demand committed to for lead periods further into the future. Then the invention provides a market hedging mechanism.

The present invention makes possible economic incentive for travellers to forecast their own travel behaviour, and enable economic incentive for travellers to commit far into the future to specific travel so that airlines need not rely on their own forecasting of demand to plan their operations.

The present invention is not limited in scope to the aforementioned.

We claim:

1. A travel forecast and allocation computing system for prospective and other travel purchasers to access for requesting, receiving, and re-allocating rights to travel on passenger transportation vehicles, comprising:
(a) forecasting means for multiple travel purchasers each to register requests in the computing system, wherein a first request, of said requests, records a binding offer to purchase travel on a mooted first journey having criteria chosen by a first travel purchaser at a fare price predetermined by said first travel purchaser, and wherein said first request provides that it may or may not be accepted, and if accepted shall be converted to a respective first right to travel, whereby, if accepted, said first request shall be serviced by said first right to travel on said first journey, and
(b) trading means for a second travel purchaser to facilitate selling of a second right of travel to a third travel purchaser, who in turn may sell said second right to travel to a fourth travel purchaser, and so forth, wherein said second right to travel was supplied as acceptance of a second request, by a travel provider, for travel on a second journey,
whereby a travel purchaser may have an opportunity of re-allocating its purchased right to travel to one or another of travel purchasers by trading it, and whereby a travel provider may have an opportunity of efficiently allocating transport to service binding travel requests and have further opportunity of relief from providing changes to reservations.

2. A travel forecast and allocation computing system of claim 1 wherein the transportation vehicles are transportation aircraft.

3. A method of forecasting, allocating, and re-allocating traveller demand for travel services comprising:
(a) providing a computing system that is accessible to prospective and other travel purchasers by remote end user terminals in a distributed network, and
(b) providing forecasting means for multiple travel purchasers each to register requests in said computing system, wherein a first request, of said requests, records a binding offer to purchase travel on a first journey having criteria chosen by a first travel purchaser at a fare price predetermined by said first travel purchaser, and wherein said first request provides that it may or may not be accepted by a first travel provider supplying a first right to travel on said first journey, and
(c) providing said first right to travel as acceptance of one of said requests, wherein said first right to travel is an assignable record of a right, registered in said computing system, provided by said first travel provider to said first travel purchaser for passenger travel on said journey of predetermined criteria, and
(d) providing trading means for said first travel purchaser to facilitate trading of said first right of travel on said computing system, to a second travel purchaser,
whereby a travel purchaser may have an opportunity of re-allocating its purchased right to travel to one or another of travel purchasers by trading it and whereby a travel provider may have an opportunity of efficiently allocating transport to service binding travel requests and have further opportunity of relief from providing changes to reservations.

4. A method of claim 3 wherein the travel services are air travel services.

5. A method of forecasting and allocating traveller demand for travel services comprising:
(a) providing a computing system that is accessible to prospective and other travel purchasers by remote end user terminals in a distributed network, and
(b) providing forecasting means for multiple travel purchasers each to register requests, wherein a first request, of said requests, records a binding offer to purchase travel on a mooted first journey having criteria chosen by said first travel purchaser at a fare price predetermined by said first travel purchaser, and where said first request provides that one travel provider, of a number of providers, may choose whether or not to put a mooted journey into service to fulfil the request, and
(c) providing a decision means for selecting some of said requests into a grouping of requests which form an economically viable scenario of travellers that may be serviced if a number of transport journeys are put into service, and
(d) accepting said grouping of requests conforming to said economically viable scenario, and
(e) providing a group of rights to travel as respective acceptance of said grouping of requests, wherein each right to travel of the group is an assignable record provided by a travel provider to a travel purchaser for a passenger right to travel on a journey of predetermined criteria,
whereby a travel provider may have an opportunity of efficiently allocating transport to service binding travel requests.

6. A method of claim 5 wherein the travel services are air travel services.

7. A method of forecasting and allocating traveller demand for travel services comprising:
(a) providing a computing system that is accessible to prospective and other travel purchasers by remote end user terminals in a distributed network, and
(b) providing forecasting means for multiple travel purchasers each to register requests, wherein a first request, of said requests, records a binding offer to purchase travel on a mooted first journey having criteria chosen by said first travel purchaser at a fare price predetermined by said first travel purchaser, and where said first request provides that one travel provider, of a number of providers, may choose whether or not to put a mooted journey into service, for the request, and
(c) providing a decision means for selecting some of said requests into a grouping of requests which form an economically viable scenario of travellers who may be serviced if a number of transport journeys are put into service, and
(d) accepting said grouping of requests conforming to said economically viable scenario, and
(e) providing a group of rights to travel as respective acceptance of said grouping of requests, wherein each right to travel of the group is an assignable record provided by a travel provider to a travel purchaser for a passenger right to travel on a journey of predetermined criteria, and
(f) providing trading means for a first travel purchaser to facilitate trading of a right of travel on said computing system to a second travel purchaser,
whereby a travel purchaser may have an opportunity of re-allocating its purchased right to travel to other travel purchasers by trading it and whereby a travel provider may have an opportunity of efficiently allocating transport to service binding travel requests and have further opportunity of relief from providing changes to reservations.

8. A method of claim 7 wherein the travel services are air travel services.
